(19) United States
(12) Patent Application Publication
(10) Pub. No.: US 2020/0236456 A1
(43) Pub. Date: Jul. 23, 2020

(54) HEADPHONES FOR PROCESSING MICROPHONE, MUSICAL INSTRUMENT, AND AUDIO SIGNALS

(71) Applicant: Marc N. Gallo, Roseland, NJ (US)

(72) Inventor: Marc N. Gallo, Roseland, NJ (US)

(21) Appl. No.: 16/749,935

(22) Filed: Jan. 22, 2020

Related U.S. Application Data
(60) Provisional application No. 62/795,137, filed on Jan. 22, 2019.

(51) Int. Cl. H04R 1/10; H04R 1/08; H04R 5/027; H04S 3/00; G06F 3/16; H04R 5/04

(52) U.S. Cl. CPC H04R 1/1041; H04R 1/1008; H04R 1/08; H04R 5/027; H04S 3/008; H04S 2400/01; G06F 3/162; H04R 5/04; H04R 2201/028; H04R 2420/07; H04R 1/1033

(57) ABSTRACT

The invention is an audio headphones device that directly connects to musical instruments or microphones, processes the musical instrument or microphone signal with guitar amp modeling or audio effects with a processor that is built-in to the headphones, and connects to audio player sources to process the audio player sources with audio effects. The invention lets the user control the amp modeling, effects parameters, and mixing of these signals via wireless and wired user-interface control connections that can be running on a separate mobile electronic device.

### CROSS-REFERENCE TO RELATED APPLICATION

This application claims priority to U.S. Provisional Patent Application No. 62/795,137, filed Jan. 22, 2019, the entire contents of which are incorporated by reference herein.

### BACKGROUND

Playing the electric guitar typically requires using a guitar amplifier. But this amplifier is not used just to make the guitar signal louder and more audible. The design of the guitar amplifier is made to also change the sound of the electric guitar, to add distortion and filtering and other effects which make the guitar sound better and more stylistic. The style and sound of the guitar amplifier is chosen to match the stylistic needs of the guitar player. And since there are many styles of guitar players and guitar playing, there are many different guitar amplifier designs to match them. There is a need to reproduce these numerous amplifier styles to satisfy the tastes of a wide range of guitarists into a single electric guitar signal reproduction product.

Playing electric guitar with an amplifier is typically a loud experience. Since the amplifier's purpose is not only to produce a stylistic sound for the guitar, but also to amplify the guitar signal volume, the one often comes with the other, meaning loud guitar volume often accompanies a stylistic amplified guitar signal. There is a need to separate the two, to allow quiet or even silent guitar playing while maintaining the stylistic tone typically associated with a loud guitar amplifier.

Playing electric guitar quietly or silently typically involves using headphones. The trouble with using headphones is that headphones do not inherently sound like the stylistic sounds of guitar amplifiers. They lack the distortion and filtering and effect characteristics of traditional guitar amplifiers.

Simulating the stylistic tone and sound of a traditional guitar amplifier requires the use of a digital signal processing system to emulate the distortion, filtering, and effects of the guitar amplifier in a compact, lightweight, power efficient, and electronically efficient way. Therefore, there is a need to incorporate a digital signal processor, which is capable of emulating traditional guitar amplifiers, into a pair of headphones.

Headphones are not designed to plug directly into an electric guitar. They are passive devices which require their own type of amplification to function. Further, the input to a headphone is not electrically compatible with the output signal of an electric guitar. There is a need to have an electronic circuit within the headphones that adapts the output signal of the electric guitar to an amplified signal that can drive the headphones properly.

There is therefore a need for a pair of headphones that can connect directly to an electric guitar, either via a wire or wirelessly, that incorporates a digital signal processor running guitar amplifier simulation algorithms, and that has its own headphone drivers, so as to allow a guitar player to play their electric guitar quietly or silently through a simulated experience of a loud guitar amplifier heard through the headphones.

### SUMMARY OF THE INVENTION

The invention is an audio headphones device that directly connects to musical instruments or microphones, processes the musical instrument or microphone signal with guitar amp modeling or audio effects with a processor that is built-in to the headphones, and connects to audio player sources to process the audio player sources with audio effects. The invention lets the user control the amp modeling, effects parameters, and mixing of these signals via wireless and wired user-interface control connections that can be running on a separate mobile electronic device.

As used herein, references to “guitar amp” and “guitar amplifiers” are to any known tube and solid state amplifiers, including tube and solid state guitar amplifiers. In addition, the term “musical instruments” includes electric guitars (including electric bass guitars), but may also include other electric instruments, such as any electric string musical instrument, including, but not limited to, electric violins, electric banjos, electric violas, electric cellos, electric double basses, electric mandolins, electric ukuleles, and electric harps.

The invention is an audio headphones device intended to interface with electric guitars and wireless audio players. The headphones allow the user to simultaneously connect to both an audio player source and an electric guitar to process these audio sources with digital effects with a built-in audio digital signal processor (DSP). The headphones will apply guitar amplifier modeling algorithms and effects to the electric guitar signal while simultaneously applying effects to the audio player signal. The headphones will mix these signals and amplify the resulting audio output to the headphone drivers for listening by the user.

The invention comprises a pair of headphones that lets the wearer simultaneously listen to music originating from a music player and to a processed musical instrument signal originating from a musical instrument or microphone plugged into the headphones. This invention is unique because whereas typical headphones plug into a music player or amplifier, these headphones plug into the output of a musical instrument or microphone directly such as a guitar output jack or vocal microphone, as examples. The invention allows the user to plug the headphones directly into any guitar and hear the sound of the instrument as if it were plugged into a traditional guitar amplifier by simulating the sounds of guitar amplifiers using guitar amp simulation software running on a digital signal processor located within the headphones. Similarly, the invention allows the user to plug the headphones directly into a microphone to hear the sound of effects like reverberation and other vocal processing effects applied to the microphone signal produced by the digital signal processor located inside the headphones. The headphones contain circuitry to adapt the high impedance output of a musical instrument or electric guitar and the low impedance output of a microphone using a preamplifier, and the headphones simulate the sound of a real guitar amplifier using guitar amp modeling DSP algorithms. The headphones also incorporate its own power amplifier and battery to power and drive the headphones and electronics without needed any additional wired connections. The headphones allow control of the settings of the simulated guitar amp and effects, the volume of the guitar signal, the volume of the music signal, and many other settings for the quality and sound via an app running on a portable mobile electronic device, such as a smartphone or tablet, using a wireless data connection such as Bluetooth or WiFi.

This invention comprises a digital audio signal processor, a rechargeable battery, a wireless audio connection, a wired audio connection, and a wireless data communication interface into a self-powered set of headphones. The practical typical embodiment of the invention is a pair of headphones that plays wirelessly-transmitted Bluetooth audio from music players, connects to electric guitars or other musical instruments/microphones via a magnetically removable audio cord, processes the electric guitar, musical instrument, or microphone signal with guitar amp modeling and/or digital audio effects algorithms, processes the audio player signal with audio effects, mixes the guitar, musical instrument, or microphone signal and audio player signal, and provides the user with a Bluetooth data interface to allow an app running on a smartphone or similar portable computing device to control the processing options, audio levels, and effects processing parameters as well as to share settings, record and share the musical instrument or vocal performance, and to network and share data with other users of similar embodiments of this invention. The practical embodiment will also connect to computing devices and power supplies via a USB or similar connection for wired control of the processing options and for recharging the internal battery. The invention may optionally use a second wireless audio interface for accepting a signal from the musical instrument in a similar way that it accepts the wireless audio playback signal.

The invention comprises a means to receive an audio signal from an external music player source. The invention can use a wireless audio receiver to receive audio signals from a wireless music player source. The invention optionally utilizes an analog audio input and analog-to-digital converter to receive audio signals from a wired music player source. This music player signal connects to the built-in audio DSP so that it can be processed with audio effects and mixing controls. The invention enables the user to listen to audio from audio players via Bluetooth/BLE or similar wireless and wired audio connections while simultaneously processing a musical instrument signal from both wireless and wired musical instrument sources with digital audio signal processing (DSP) effects. The headphones enable the user to mix these signals for controlled listening.

This invention comprises a means to receive an audio signal from a musical instrument, such as an electric guitar or microphone. The invention optionally uses a wire to plug directly to an electric guitar or other similar musical instrument or microphone. The headphones comprise a musical instrument preamplifier and analog-to-digital converter to receive analog audio signals from the musical instrument or microphone input. The headphones also optionally comprise a wireless audio receiver to receive audio signals from a wireless guitar or wireless microphone audio transmitter. The digitized musical instrument/microphone signal feeds the built-in audio digital signal processor so that it can be processed with guitar amp modeling or effects. The invention allows the user to simultaneously play the instrument or microphone, process the instrument or microphone signal with guitar amp modeling and audio effects algorithms, hear the processed musical instrument or microphone signal sound in real-time, and, optionally, listen to music sent to the headphones wirelessly.

The headphones comprise a wired connection to a musical instrument source, typically an electric guitar or microphone. The headphones connect to the electric guitar via a wireless signal or via a guitar cable. The guitar cable is specially designed with a standard ¼″ phone plug on one end for connecting to the standard ¼″ guitar jack on typical electric guitars, and a magnetically locking multi-pin connector on the other end of the cable for connecting to a mating connection on the headphones. The microphone cable is specially designed with a standard XLR plug on one end for connecting to standard XLR microphones, and a magnetically locking multi-pin connector on the other end of the cable for connecting to a mating connection on the headphones. The magnetic locking feature allows the user to connect and disconnect the cable to/from the headphones easily, conveniently converting the headphones into standard wireless music headphones by quick removal of the cord. The magnetically removable cord also protects the headphones and the user if the cable accidentally gets caught or snagged and pulls on the headphones. In this case, the magnetic connection will simply release the cord and release the tension on the user and headphones. Optionally or additionally, the headphones can provide a traditional connector without magnetic connection for standard audio input cables.

In the case where the musical instrument, such as an electric guitar or bass, is connected to the headphones using a wired connection/cable, the headphones will comprise a preamplifier circuit buffer which will have a high impedance input and drive a low impedance output. This preamp will have enough gain to properly match the guitar output to the input of the headphone's electronics.

In the case where a microphone is connected to the headphones using a wired connection/cable, the headphones will comprise a preamplifier circuit buffer which will have a low impedance input and drive a low impedance output. This preamp will have enough gain to properly match the microphone output to the input of the headphone's electronics.

The invention may comprise a phantom powered preamplifier into the musical instrument cable. This may comprise a preamp to be placed at the instrument end of the instrument cable, used to amplify the guitar signal or microphone signal close to the instrument source, ideally at the connector, to reduce noise and allow use of smaller diameter cables with higher capacitance without introducing unwanted noise and frequency dependent effects. This cable may have a FET-based preamplifier close to or part of the connector at the instrument end of the cable so that the signal can be amplified before running along the length of the cable towards the input connector on the headphones.

The invention comprises a built-in digital audio signal processor (DSP) to process the incoming musical instrument or microphone signal with guitar amplifier modeling and audio effects, to process the incoming music player signal with audio processing and effects, to mix these signals, and to process the resultant mix with additional audio effects, level control, equalization, dynamics control, and other audio processes for user-adjustable listening.

The digital audio signal processor will apply guitar amp modeling and simulation software to mimic the effects of real guitar amplifiers and effects processors. The digital audio signal processor will also apply vocal processing effects.

The digital signal processor (DSP) provides audio effects and guitar amplifier emulation. This guitar amplifier emulation is the process where the effects caused by a real guitar amplifier to produce a perceived guitar stylistic sound are simulated using digital software. The guitar emulation software will simulate various components inside a real guitar amplifier that contribute to its stylistic sound including distortions, clipping, dynamic effects, currents and voltages and their interactions inside a guitar amp, vacuum tube characteristics, diode characteristics, transistor characteristics, reactive loading of the amplifier, filtering characteristics of circuits within the amplifier, and other effects that naturally occur in a real guitar amplifier. The guitar amplifier emulation will also emulate the effects of a guitar loudspeaker and cabinet system, which unlike most full range speaker systems which reproduce all frequencies equally, filters the guitar signal and produces some frequencies louder than others. The guitar amplifier emulation will reproduce this filtering effect in a manner that mimics the same effect produced by real guitar loudspeakers. The DSP will also produce effects including tremolo, chorus, flanger, artificial reverberation, delay, echo, filtering, compression, expansion, noise gate, overdrive pedal simulation, distortion, phaser, pitch shifting, and other effects to the guitar signal, microphone signal, or music player playback signal. The DSP will also measure the pitch of the guitar signal to provide a tuner function to allow the user to tune the instrument. This tuner information can be sent to a separate wirelessly connected portable electronic device such as a phone or tablet which can display the tuner information for real time adjustment.

The invention may use a CPU or microprocessor or microcontroller in place of the digital signal processor or DSP to perform similar functions.

The digital signal processor (DSP) of the subject invention may utilize digital audio processing as set forth in U.S. Pat. No. 8,271,109, issued on Sep. 18, 2012, and U.S. Pat. No. 8,275,477, issued on Sep. 25, 2012, which are both incorporated by reference herein.

A typical embodiment of this invention is an audio headphones device that connects to an electric guitar via a wire that plugs into the output jack of the guitar, connects to a music player source via a Bluetooth/BLE or similar wireless connection, and connects to a user control app running on a portable smartphone or similar wireless computing device via a Bluetooth/BLE or similar wireless connection or wired USB or similar connection. In this typical embodiment, the headphones device receives audio signals from the guitar and the music player source, it processes these signals with guitar amp modeling algorithms and audio effects via a built-in digital signal processor (DSP), and it mixes these signals and amplifies them to be listened to by the user. This typical embodiment of this invention will also allow the user to control the settings of the audio processing, mixing levels and other features of the audio headphones device via a control app running on a smartphone or similar computing device connected to the audio headphones device via a Bluetooth/BLE or similar wireless connection or via an app running on a computing device connected to the audio headphones device via a USB or similar wired connection. The invention will also apply tube amp emulation on the musical instrument signal to simulate the sounds of real guitar and musical instrument amplifiers.

The invention comprises an analog audio output, to allow connection to the inputs of external amplifiers, recorders, and other audio equipment so that the headphones can be used as a standalone audio processor or direct recording device and musical instrument preamp.

The invention may be used as an audio interface to a computer or laptop or other digital audio recording system, to be used to allow digital audio originating from the musical instrument to be recorded by the recording system or computer, and to allow digital audio originating from the recording system or computer to be played back into the headphones.

The invention comprises headphones that mount to a user's head positioned near the user's ears enabling them to hear audio that is generated or mixed by the audio DSP processor built into the headphones.

The invention comprises an audio amplifier to drive the headphone loudspeaker drivers with the mixed and processed audio signal.

The invention comprises an internal rechargeable battery that powers the unit while it is being worn and used by the user. The battery is rechargeable by an external power supply or USB cable which connects to the headphones via a USB or similar wired communication port.

The invention comprises a wired and/or wireless data/control interface for controlling the audio digital signal processing, effects, and guitar amp modeling algorithms. This data/control interface will connect to computing devices such as smartphones, tablets, laptops, computers, and other computing devices via a wired USB or similar wired connection, or via a wireless Bluetooth, BLE or similar wireless connection. These computing devices will be able to control the headphones through software and apps communicating with the headphones through this wired or wireless data/control interface. The wired or wireless data/control interface will allow reprogramming of the internal processor and firmware. The wired interface will also support powering and charging of the headphones.

The application, or app, running on a portable electronic device such as a phone or tablet, will allow the user to control the effects and algorithms running on the digital signal processor (DSP) located inside the headphones. The purpose of this app is to allow the user to wirelessly adjust all the parameters of the effects. These parameters include gain control, tone control, bass control, treble control, amplifier emulation selection, cabinet emulation selection, effects parameters controls, eq filter parameter controls, distortion amounts, levels, mixing ratios, volume of the various signals, pitch shifting of the music playback, speed of the music playback, level and mix of the music playback, reverberation style adjustments, echo parameter adjustments, and other audio effect parameters and options. These parameters and options are displayed in the app in a graphical user interface (GUI) which will utilize graphical objects and methods to adjust the parameters such as sliders, pull-down menus, text boxes, data entry, knobs, wheels, toggle buttons, radio buttons, and other GUI elements to allow the user to select and control the options and parameters that control the digital signal processor (DSP) and its algorithms.

The invention will allow the user to share settings, sounds, recordings, presets, and other data with other users via an app through the connections provided by the headphones, the connected computing device, and any networks to which the headphones and computing device are connected. The invention will optionally connect to the internet to facilitate this sharing using wireless and/or wired connections with others, including those that use the same headphones.

The invention will allow the user to record the musical instrument, guitar, or vocal microphone signal and transfer these recordings to a host computing device via the wireless and/or wired data/control interfaces.

The invention will allow multiple users of the same headphones to hear each other playing and share sounds and effects settings via its wired and/or wireless connections.

The invention will interact with cloud-based applications to allow DSP parameter and options settings to be shared with other users on the internet. In this way, a user can share a particular sound they set up on their headphones with someone else who then can hear the same sound in their headphones of this invention. The cloud-based application will also allow users to share pre-recorded sounds made with the headphones or other sources so that other users can play them back and audition them directly using their headphones of this invention. Further, the cloud-based application will enable users to play their musical instrument using their headphones into the headphones of another user in real-time. This will allow two users in separate locations to hear each other simultaneously as they play and process their musical instruments and share their sounds with each other in real time.

### BRIEF DESCRIPTION OF THE DRAWINGS

FIG. 1 shows a pair of headphones in accordance with the subject invention;

FIG. 2 shows possible components of a pair of headphones in accordance with the subject invention; and,

FIG. 3 shows interaction of a plurality of headphones with various devices in accordance with the subject invention.

### DESCRIPTION OF THE INVENTION

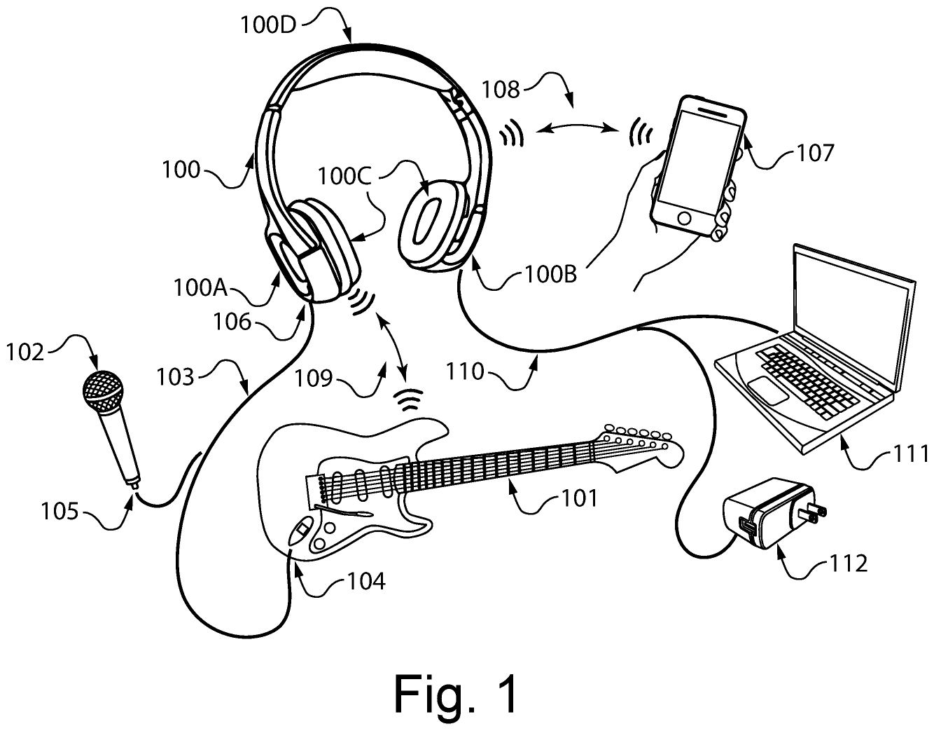

FIG. 1 depicts one embodiment of the invention. A pair of headphones (100) are to be worn on the head of a listener and connect to a musical instrument, such as an electric guitar (101), via a cable (103). The headphones (100) include a pair of earcups (100A, 100B), each provided with a speaker (100C) for transmitting sound into the ears of a wearer of the headphones (100). A strap (100D), which may be adjustable, is provided to support the earcups (100A, 100B).

The cable (103) has a plug (104) on one end for mating with a jack on the musical instrument (101). In most cases, this will be a ¼″ phone plug (104). Alternatively, the headphones (100) can connect to a microphone (102) using a similar cable (103). In this case, the cable (103) has a connector (105) on one end for mating with the input receptacle of the microphone (102). In most cases, this will be an XLR connector (105). In either case of using a musical instrument connection or a microphone connection, the second end (106) of the cable (103) will include a connector that mates with at least one of the earcups (100A, 100B) of the headphones (100) to carry the input audio signal, either from the musical instrument or the microphone, into the inner processing electronics of the headphones (100). The end connector (106) can be either a plug or a magnetically attachable connector. In the case of a plug, the plug (106) will mate with a compatible jack located in one of the earcups (100A, 100B) of the headphones (100). In the case of a magnetically attachable plug, the plug (106) may include of a set of pins that connect with a compatible receptacle on one of the earcups (100A, 100B) of the headphones (100), and will be held in contact by magnetic attraction between a magnet located on one of the plug (106) and the headphones (100) and an attracting surface located on the opposite mating surface.

Alternatively, the musical instrument (101) or microphone (102) can transmit a digital audio signal to the headphones (100) via a wireless digital audio connection (109) to a wireless digital audio receiver located within at least one of the earcups (100A, 100B) of the headphones (100).

As discussed below, a digital signal processor (DSP) is a computer processing unit (CPU) located within the headphones (100) which is configured to process an input audio signal received by the headphones (100) generated by a user playing the musical instrument (101). The DSP/CPU may digitally modify the received input audio signal by applying guitar amp simulation algorithms, audio effects, and mixing effects to create a digitally-modified audio signal. The headphones (100) may include acoustic drivers to amplify the digitally-modified audio signal, thereby producing the simulated sound of a real guitar amp, mixed with music playback, into the ears of the listener.

The DSP/CPU may digitally modify the received input audio signal using any known processing, including, but not limited to, any of the processing disclosed in U.S. Pat. Nos. 8,271,109 and 8,275,477.

The headphones (100) may be also configured to communicate with an external computing device, such as a portable electronic device (107) (typically a phone or tablet), or a computer (111), via a wireless network connection (108). The external computing device may run control application software providing a user with an interface to interact with the headphones (100). This enables the user to control the DSP/CPU to adjust audible signals, adjust settings of the audio processing including selection of guitar amplifier emulation, effects settings, mix settings, and more. The wireless network connection (108) also allows the user to share recordings, listen to other recording, listen to other users playing their musical instrument, and share settings of the listening experience with others.

Optionally, the external computing device, such as a computer (111) or portable electronic device (107) may connect to the headphones (100) by means of a wired computer port connection (110), which could be a USB, Thunderbolt, or similar computer interface. This computer interface would also allow similar functionality to that of the wireless network connection (108), but could also supply power to recharge the internal power supply and battery located within the headphones (100). An external battery charger (112) could also connect to the headphones (100) to charge the internal power supply and battery either through a coaxial DC power plug, USB, Thunderbolt, or similar powered line connection.

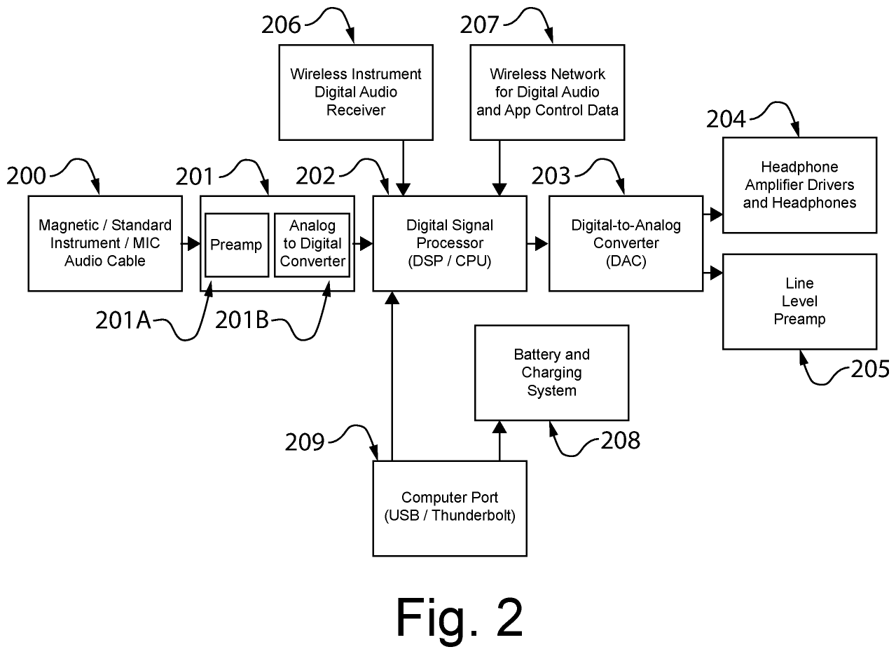

FIG. 2 depicts the system of components which comprise the inner workings of the headphones. The musical instrument/microphone input (200) allows for the connection of a musical instrument, such as an electric guitar or a microphone, to the headphones by means of an audio cable. This cable will have on one end a plug to attach to either a musical instrument (101) or a microphone (102). In the case of a musical instrument (101), this plug may be a ¼″ phone plug or similar to connect to the output jack of the musical instrument (101). In the case of a microphone (102), this plug may be an XLR or similar plug to connect to the output pins of the microphone (102). The other end of the cable may be either a plug or a magnetically attachable connector. In the case of a plug, this end will attach to the headphones (100) with a compatible socket to allow for the audio connection to be made between the musical instrument (101)/microphone (102) and the headphones (100). In the case of a magnetically attachable connector, this end will attach to the headphones (100) using a compatible, magnetically attracted receptacle for the connector to allow for the audio connection to be made between the musical instrument (101)/microphone (102) and the headphones (100).

A musical instrument/microphone input (200) is connected to a preamp (201A) and analog-to-digital (ADC) (201B) converter, together acting as a receiver (201). The musical instrument/microphone input (200) provides a connection for the wire 103, described above. The preamp (201A) is designed to interface the electrical impedance of the musical instrument (101)/microphone (102) to the input impedance of the ADC (201). In the case of a musical instrument (101), the preamp (201A) will have a high input impedance and moderate gain to adapt the musical instrument (101) signal to the voltages and currents required by the ADC (201B) for proper analog to digital conversion. In the case of the microphone (102) input, the preamp (201A) will have a low input impedance and a high gain to adapt the microphone (102) signal to the voltages and currents required by the ADC (201B). The ADC (201B) then converts this signal produces by the preamp (201A) into a digital stream of information representing the voltage at the musical instrument/microphone input (200), measured and samples at regular intervals of time. This digital stream of samples is then fed by the ADC (201B) into the digital signal processor (DSP)/CPU (202).

Optionally, a wireless instrument digital audio receiver (206) will accept a wirelessly transmitted digital signal from a musical instrument or microphone digital audio transmitter. This signal will represent the audio signal of the musical instrument or microphone sampled at regular intervals of time, made by the external wireless transmitter. The wireless digital audio receiver (206) receives this signal and feeds it into the digital signal processor (DSP)/CPU (202) as an alternative input signal to the one produced by the ADC (201B).

A wireless network module (207), can also connect to the DSP/CPU (202) to supply it with a digital audio signal originating from a music player or other network source of audio, such as another remotely located musician or musical instrument. The DSP/CPU (202) accepts this digital audio signal along with the digital musical instrument signal from the receiver (201) so that it can process and mix these signals together in ways directed by the user. A non-transitory memory may be provided with the headphones (100) for storing audio files, including pre-recorded playings of a user, and remotely obtained audio files, such as from other musicians or the Internet.

The wireless network module (207) may also receive data from a network, such as control data (control commands from application software running on an external portable device, such as a phone, tablet, or computer), to adjust the settings, options, selections, and control of the DSP/CPU (202). This control includes mixing, effects settings, and guitar amplifier simulation selection and options. The wireless network module (207) may also supply network data for firmware updates to the DSP/CPU (202), internet connectivity for IoT (internet of things) connectivity and apps, sharing presets and sound with other users, and simulcasting audio with other users of similar equipment. The wireless network module (207) can use Bluetooth, WiFi, BLE, or other wireless technology standards.

In either case, the digital signal processor (DSP)/CPU (202) processes the signal arriving from the receiver (201) and/or wireless instrument digital audio receiver (206). This process is controlled by the commands and data that arrive from the Wireless Network Module (207). The DSP/CPU (202) applies guitar amp emulation algorithms to the musical instrument signal to simulate the stylistic effects of a real guitar amplifier, including distortion, vacuum tube emulation, transistor emulation, diode emulation, echo, reverberation, modulation effects, compression, noise reduction, loudspeaker and loudspeaker cabinet emulation, and other guitar related effects. The DSP/CPU (202) also applies audio effects to the microphone input such as compression, equalization, echo cancellation, noise reduction, pitch shifting, and other vocal related effects. The DSP/CPU (202) mixes these signals, along with any digital music signal(s) that may be arriving from the Wireless Network Module (207), giving the user control of the audio level of each of these signals for custom balancing and blending of the signals as they travel toward the headphone drivers and the user's ears. Although not shown, a non-transitory electronic memory may be provided in the headphones (100) communicatively linked with the DSP/CPU (202) to allow for storage or retrieval of data, including audio files, such as pre-recorded audio files created by a user, and/or audio files obtained from remote sources, such as other users and/or downloaded audio files obtained via the wireless network module (207).

After processing by the DSP/CPU (202), the digital audio output signal is sent to the digital-to-analog (DAC) converter (203). The DAC (203) converts the digital audio output signal to an analog audio output signal capable of driving analog electronics like headphones and line level outputs. The DAC (203) feeds this analog output signal to the headphone amplifier (204), which drives the headphone drivers (204) thereby producing the sound that ultimately leaves the speakers (100C) of the headphones (100) to travel towards and into the listener's ears.

Optionally, the analog output signal can feed a line level preamp (205) which will drive external analog audio inputs, providing a line level audio output which can feed external audio devices, mixers, amplified speakers, amplifiers, and other external audio equipment.

A computer port (209), such as a USB, Thunderbolt, or similar computer data communication port, may connect to the DSP/CPU (202). The computer port (209) may provide a connection for the wired computer port connection (110) described above. This allows for a directly connected computer to access the audio streams allowing the headphones (100) to act as a computer audio interface. This also allows for the computer to stream audio that it obtains from other sources for listening through the headphones (100). The computer port (209) also allows for firmware/software updates within the DSP/CPU (202), control of the DSP/CPU (202) algorithms options and parameters, and charging of the headphones battery system (208).

All of the components discussed above, and shown in FIG. 2, may be located in one or both of the first and second earcups (100A, 100B) and/or along the strap (100D). The receiver (201), the DSP/CPU (202), the DAC (203), the headphone amplifier and drivers (204), the wireless digital audio receiver (206), the wireless network module (207), the line level preamp (205), the computer port (209), and other support electronics and systems may require electrical power to function. Electrical power, power voltage and current conversion, and electrical power regulation may be supplied by the battery and charging system (208). The battery and charging system (208) may include a rechargeable battery to power the systems without need for a wire A charging circuit to recharge the battery (208) when the headphones (100) are connected to an external power source, and power regulators to convert the battery voltage to the required voltages for the various electronics systems may be provided in the headphones (100). The battery and charging system (208) may also possess a battery measurement and management system to provide charge, condition, and life expectancy status of the battery. The battery and charging system (208) may receive external power for recharging from either an external power adapter via a coaxial DC power jack, the external computer port (209), e.g., via a USB port connector, Thunderbolt port connector, or similar computer powered port, or a wireless charging station adapter.

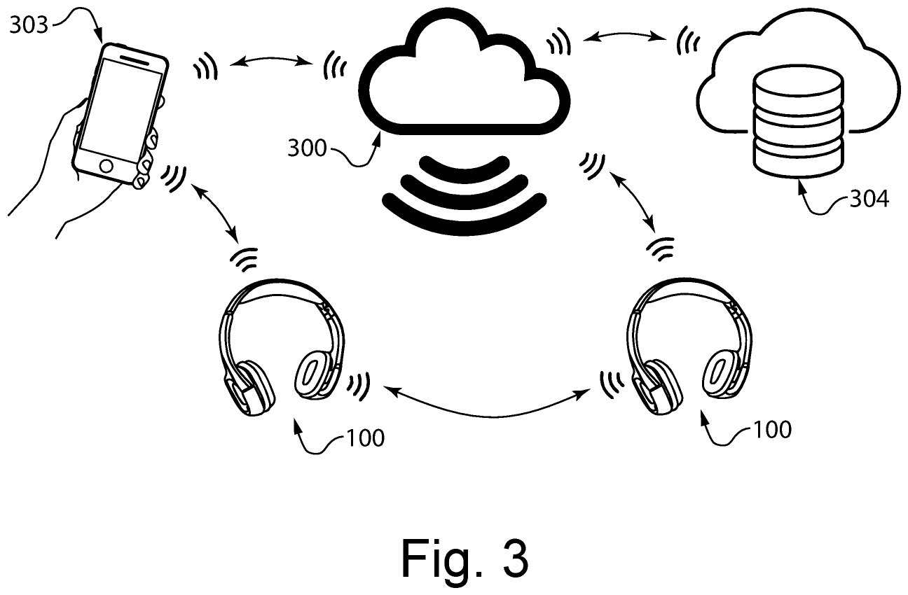

FIG. 3 depicts a connectivity diagram that illustrates how the headphones (100) interact with the internet/cloud (300), external computing devices (303), and application software running on either an external computing device (303) or a web-based server (304) connected to the internet/cloud. FIG. 3 shows two of the headphones (100), but any quantity may be utilized as discussed herein, particularly relative to the internet/cloud (300).

The headphones (100) make a connection to the internet/cloud (300) either directly by using a built-in WiFi or similar wireless or wired network connection, or indirectly by using a built-in Bluetooth or similar wireless or wired network connection to first connect to an external computing device (303), which in turn establishes a further connection to the internet/cloud (300) by its own means, typically the WiFi or wired network connection of the external computing device (303).

Once the connection, made either directly or indirectly, between the headphones (100) and the internet/cloud (300) is established, the headphones (100) can communicate and share information with any other device connected to the internet/cloud (300), including other similar headphone units (100) and web-based servers (304). This allows for the user of one set of headphones (100) to share settings, recordings, sounds, real-time audio streams, and presets, with another user of another set of headphones (100). These connections also allow for the user of one set of headphones (100) to play together with another user of another set of headphones (100) in real-time while both are able to hear each other in their respective headphones (100) simultaneously. The presence of a web-based server (304) allows further for the headphones (100) to obtain assets like firmware updates, presets, new amplifier emulation software algorithms, new effects algorithms, presets, and playback music from the web server. Alternatively, the headphones (100) can obtain the same assets from application software running on the external computing device (303), which indirectly obtains this information from the internet/cloud (300) by its own means and relays them to the headphones (100). The web server (304) can act as an intermediate storage device between one pair of headphones (100) and another pair of headphones (100). This allows for information to be transferred between two sets of headphones (100) by queuing the information so that it can be sent when one set of headphones (100) is ready to send, and received by the other set of headphones (100) when it is ready to receive it, even if it is at some much later time in the future. This facilitates messaging between two sets of headphones (100) to support social media communication and other types of communication that may not be able to happen in real time.

The applications running on both the web server (304) and external computing devices (303) allow for all types of connections between any two users using any pair of headphones (100) for real time control, listening, and sharing of audio based content, including musical instrument and vocal processing streams, and those occurring in real time as during live performances.

The connection between an external computing device (303) and the headphones (100) allows the user to control settings on the headphones, specifically settings for adjusting the guitar amplifier emulation algorithms, to select the style of amplifier setting, adjust the amplifier gain and tone, and for setting the effects options and choices by interacting with the graphical user interface of the external computing device (303). This permits control of the headphones (100) without having to remove them from the user's head for adjustment. The also allow remote control of the settings of the headphones from a device that is remotely and wirelessly connected to the headphones. It also allows for a distant remote control of the headphones from another user connected to the internet/cloud (300).

Any of the computing devices discussed herein may be provided with a processor having a set of instructions stored therein in a non-transitory electronic memory that when executed carries out the noted processes or function of the computing devices. Any of the computing devices may be provided with an interface (e.g., a graphical user interface (GUI)) to allow for interaction as described herein. For example, the portable electronic device (107) may be provided with an interface to allow a user to control the DSP/CPU (202).

What is claimed is:

1. A pair of headphones configured to be worn on a user's head to project digitally-modified sound from a musical instrument into the user's ears, the pair of headphones comprising:
a first speaker in a first earcup;
a second speaker in a second earcup;
at least one receiver to receive a sound signal generated by the user playing the musical instrument;
at least one Digital Signal Processor (DSP) configured to digitally modify the received sound signal to simulate the effects on the received sound signal of a tube or solid state amplifier;
at least one digital-to-analog converter to convert the digitally-modified sound signal into an analog audio output signal; and,
at least one internal amplifier driver to amplify the analog audio output signal for outputting the analog audio output signal through the first and second speakers.

2. The headphones as in claim 1, wherein the at least one receiver is connected to the musical instrument via a wire.

3. The headphones as in claim 2, wherein the wire includes a plug for connecting to an output jack on the musical instrument.

4. The headphones as in claim 2, wherein the wire includes a magnetic connector for magnetically attaching to at least one of the first and second earcups.

5. The headphones as in claim 1, wherein the at least one receiver is wirelessly connected to the musical instrument.

6. The headphones as in claim 1, further comprising:
a wireless network radio transmitter and receiver; and,
a wireless network connection enabling connection to the Internet.

7. The headphones as in claim 6, wherein the wireless network connection is a WiFi connection.

8. The headphones as in claim 6, wherein the wireless network connection is a Bluetooth connection.

9. The headphones as in claim 1, wherein the at least one DSP is configured to mix the digitally-modified sound signal and a secondary digital audio signal.

10. The headphones as in claim 9, wherein the secondary digital audio signal is stored in a non-transitory electronic memory.

11. The headphones as in claim 9, wherein the secondary digital audio signal is obtained via a wireless network connection.

12. The headphones as in claim 1, further comprising an interface for communication with a personal computer.

13. The headphones as in claim 12, wherein the interface allows for power transmission to power the pair of headphones.

14. The headphones as in claim 12, wherein the interface allows for receiving and transmission of data.

15. The headphones as in claim 12, wherein the interface is a Multichannel Digital Audio Interface.

16. A headphones system comprising:
a pair of headphones as set forth in claim 1; and,
a portable electronic device having a processor operable by a program of instructions stored in a non-transitory electronic memory that, when executed, provides an interface for control over the DSP.

17. A pair of headphones configured to be worn on a user's head to project digitally-modified sound from a microphone into the user's ears, the pair of headphones comprising:
a first speaker in a first earcup;
a second speaker in a second earcup;
at least one receiver to receive a sound signal generated by the user using the microphone;
at least one Digital Signal Processor (DSP) configured to digitally modify the received sound signal to simulate the effects on the received sound signal of a tube or solid state amplifier;
at least one digital-to-analog converter to convert the digitally-modified sound signal into an analog audio output signal; and,
at least one internal amplifier driver to amplify the analog audio output signal for outputting the analog audio output signal through the first and second speakers.
